(19) United States
(12) Patent Application Publication
(10) Pub. No.: US 2012/0055514 A1
(43) Pub. Date: Mar. 8, 2012

(54) RAIL CONNECTION RESTORATION AND METHOD FOR CLEANING FUEL INJECTOR WITHOUT DISASSEMBLY

(76) Inventors: Philip James Charles Vince, Columbia, SC (US); Daryl Villa, Ridgeway, SC (US); Martin Heiner Luedicke, Columbia, SC (US)

(21) Appl. No.: 13/044,298

(22) Filed: Mar. 9, 2011

Related U.S. Application Data
(60) Provisional application No. 61/312,207, filed on Mar. 9, 2010.

(51) Int. Cl. B08B 9/032; B23P 6/00; B08B 3/08

(52) U.S. Cl. 134/22.18; 29/402.04

(57) ABSTRACT

A method for restoring a rail connection interface of a fuel injector and/or a method for cleaning the fuel injector. The method comprises inspecting a rail connection interface of the fuel injector, and restoring the rail connection interface. The method may further comprise connecting a flush line to at least one of a nozzle or a fuel inlet hole of a cone nut of the fuel injector, pressurizing a cleaning solution, and supplying the pressurized cleaning solution to the flush line.

### CROSS REFERENCE TO PRIOR APPLICATIONS

This application claims the benefit from U.S. Provisional Patent Application No. 61/312,207, filed on Mar. 9, 2010, the disclosure of which is hereby incorporated herein by reference for all purposes as if fully set forth herein.

### FIELD OF THE DISCLOSURE

This disclosure is directed to a method and device for rail connection restoration and a method for cleaning a fuel injector without disassembly.

### BACKGROUND OF THE DISCLOSURE

Remanufacturing processes for used fuel injectors typically include time consuming and labor intensive disassembly and cleaning procedures. These procedures may expose certain components of the fuel injectors to irreparable damage, resulting in additional scrap. Disassembly may also disturb the integrity of sealing joints, which in turn may lead to rework requirements in order to recreate a seal.

For example, a fuel injector nozzle assembly may have a sealing joint with a spring cage that may require extensive cleaning prior to reuse. Additionally, the nozzle assembly may be a part of a stack of other components, including an upper disk, a lower disk, and an injector body, which may be held together by a cone nut. Disassembly of the nozzle assembly for cleaning may require most, if not all of the fuel injector components to be separated before cleaning, including the upper and lower disks, as well as the injector body, thereby disturbing the sealing joints provided in the fuel injector.

In some instances, a component of the fuel injector may become so worn that it may need replacement before the fuel injector may be reused. For instance, during harsh or prolonged operating conditions, an upper portion of fuel injector may wear to a point where it must be repaired or replaced before the fuel injector may be reused. In particular, the rail connection interface of a fuel injector may be so worn that the fuel injector control valve may not be reusable. Since there is no current rework procedure available for repairing or restoring the rail connection interface, these worn control valves are typically scrapped.

The present disclosure provides a novel process for cleaning a fuel injector without having to disassemble the injector. The present disclosure also provides a device and a method for restoring a worn rail connection (or tube) interface of a fuel injector to its original specification.

### SUMMARY OF THE DISCLOSURE

According to an aspect of the disclosure, a method is disclosed for restoring a rail connection interface of a fuel injector and cleaning the fuel injector. The method comprises: inspecting a rail connection interface of the fuel injector; restoring the rail connection interface; connecting a flush line to at least one of a nozzle or a fuel inlet hole of a cone nut of the fuel injector; pressurizing a cleaning solution; and supplying the pressurized cleaning solution to the flush line. The method may further comprise vibrating the pressurized cleaning solution. The cleaning solution may comprise a chemical agent and/or a biological agent. The restoring the rail connection interface may comprise: machining the rail connection interface; and installing an insert in the machined connection interface. The restoring the rail connection interface may comprise: preparing the rail connection interface; and depositing a material on the prepared rail connection interface. The preparing the rail connection interface may comprise: cleaning the rail connection interface; and/or depositing a bonding substrate to the rail connection interface. The supplying the pressurized cleaning solution to the flush line may comprise: introducing the pressurized cleaning solution into the nozzle of the fuel injector; or introducing the pressurized cleaning solution into the fuel inlet hole of the cone nut of the fuel injector.

According to a further aspect of the disclosure, a method is disclosed for cleaning a fuel injector. The method comprises: connecting a flush line to at least one of a nozzle or a fuel inlet hole of a cone nut of the fuel injector; pressurizing a cleaning solution; and supplying the pressurized cleaning solution to the flush line. The method may further comprise: vibrating the pressurized cleaning solution. The cleaning solution may comprise a chemical agent and/or a biological agent. The supplying the pressurized cleaning solution to the flush line may comprise: introducing the pressurized cleaning solution into the nozzle of the fuel injector; or introducing the pressurized cleaning solution into the fuel inlet hole of the cone nut of the fuel injector.

According to still further aspect of the disclosure, a method is disclosed for restoring a rail connection interface of a fuel injector. The method comprises: inspecting a rail connection interface of the fuel injector; and restoring the rail connection interface. The restoring the rail connection interface may comprise: machining the rail connection interface; and installing an insert in the machined connection interface. The restoring the rail connection interface may comprise: preparing the rail connection interface; and depositing a material on the prepared rail connection interface. The preparing the rail connection interface may comprise: cleaning the rail connection interface; and/or depositing a bonding substrate to the rail connection interface.

Additional features, advantages, and embodiments of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows a cross-section view of an example of a fuel injector;

FIG. 2 shows a view of a control valve body of the fuel injector of FIG. 1 with an insert, according to principles of the disclosure;

FIG. 3A shows an example of a restoring process that may be performed to restore a rail connection interface in, for example, the fuel injector of FIG. 1;

FIG. 3B shows another example of a restoring process that may be performed to restore the rail connection interface in, for example, the fuel injector of FIG. 1;

FIG. 4 shows an example of a cleaning system that is constructed according to the principles of the disclosure; and

FIG. 5 shows an example of a cleaning process, according to the principles of the disclosure.

The present disclosure is further described in the detailed description that follows.

### DETAILED DESCRIPTION OF THE DISCLOSURE

The embodiments of the disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure, which is defined solely by the appended claims and applicable law. Moreover, it is noted that like reference numerals represent similar parts throughout the several views of the drawings.

A “computer”, as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, or the like, or an array of processors, microprocessors, central processing units, general purpose computers, super computers, personal computers, laptop computers, palmtop computers, notebook computers, desktop computers, workstation computers, servers, or the like. Further, the computer may include an electronic device configured to communicate over a communication link. The electronic device may include, for example, but is not limited to, a mobile telephone, a personal data assistant (PDA), a mobile computer, a stationary computer, a smart phone, mobile station, user equipment, or the like.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

A “computer-readable medium”, as used in this disclosure, means any medium that participates in providing data (for example, instructions) which may be read by a computer. Such a medium may take many forms, including non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards, Bluetooth, or the like.

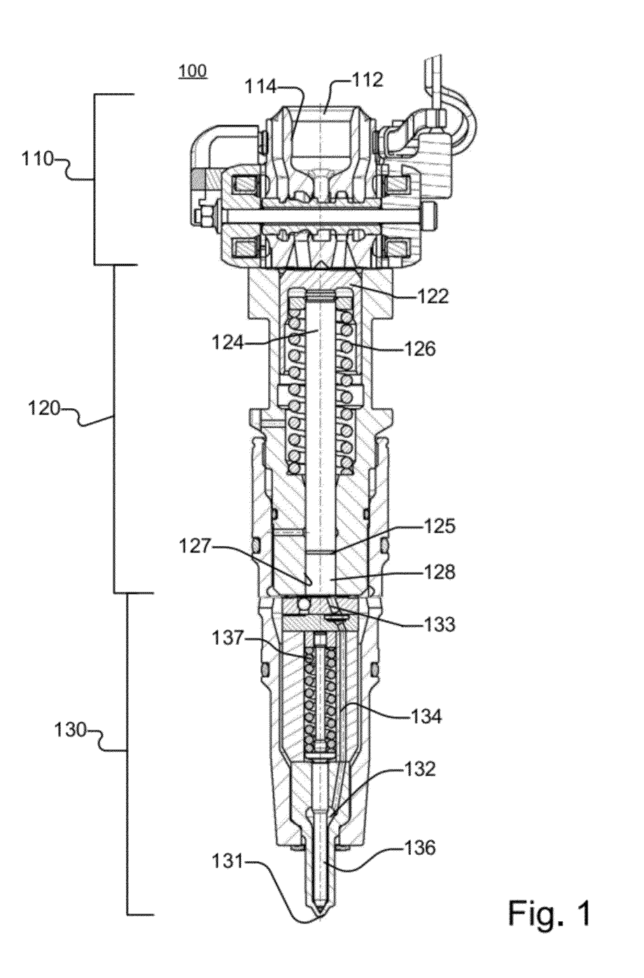

FIG. 1 shows a cross-section view of an example of a fuel injector 100. The fuel injector 100 includes, for example, a control valve body 110, an intensifier body 120, and a nozzle assembly 130. The control valve body 110 includes a fluid inlet port 112 and a rail connection interface 114. The intensifier body 120 includes a piston 122, a plunger 124, an intensifier spring 126, and a high pressure chamber 128. The high pressure chamber 128 is formed by the end surface 125 of the plunger 125 and the walls 127 of the intensifier body 120. The nozzle assembly 130 includes a nozzle 131, a fill path 133, a fuel bore 134, a fuel chamber 132, a needle 136, and a spring cage 137.

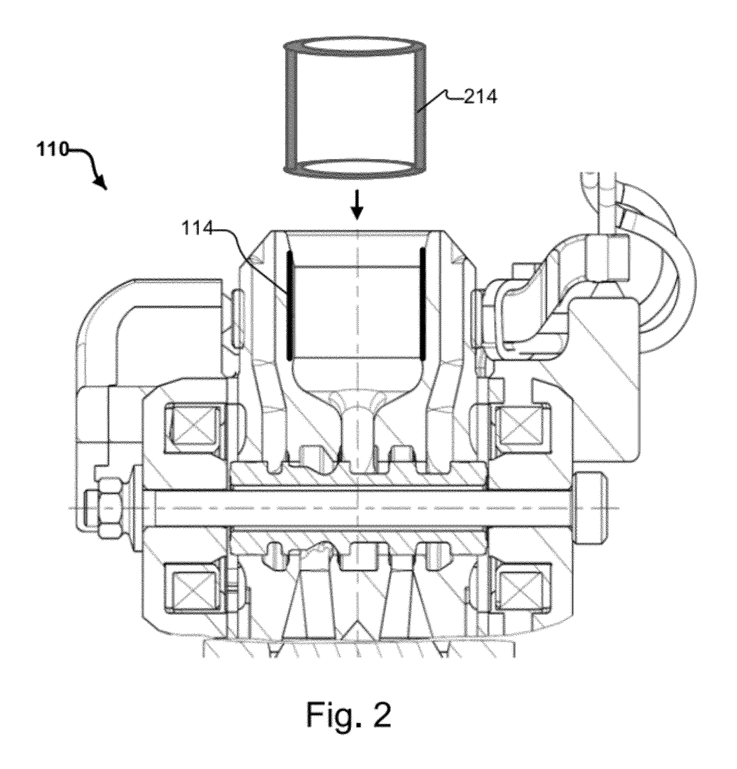

FIG. 2 shows a cross-section view of the control valve body 110 of the fuel injector 100 with an insert 214, according to principles of the disclosure. After harsh or prolonged use, the rail connection interface 114 may be substantially worn, such that the control valve body 110 may leak. According to the principles of the disclosure, the surface of the rail connection interface 114 may be restored to, for example, original equipment manufacturer (OEM) specifications by inserting the insert 214 in the fluid inlet port 112 of the control valve body 110. The insert 214 may include, for example, a sleeve, a cylinder, a plurality of interlocking plates that form a cylinder, or the like. The insert may also include retaining features, such as, for example, under cuts, grooves, threads or fiction/bonding surfaces. The insert 214 is made from a material that is sufficiently hard and durable, at least as hard and durable as the original material of the control valve body 110. The material may include a metal such as, for example, steel.

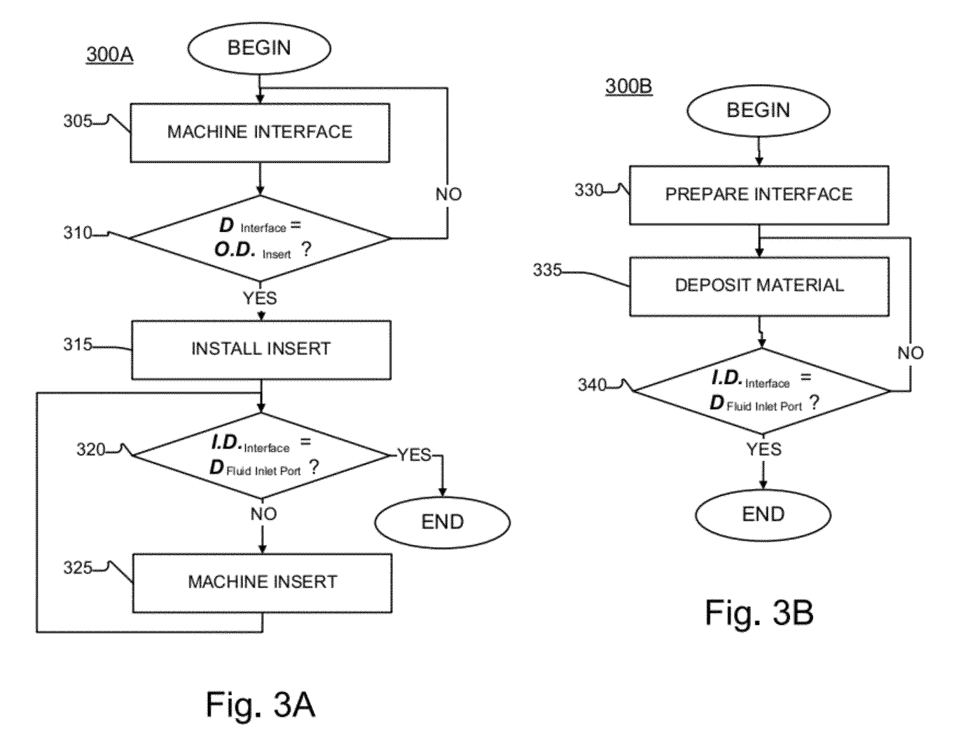

FIG. 3A shows an example of a restoring process 300A that may be performed to restore the rail connection interface 114 to, for example, OEM specifications. Referring to FIGS. 2 and 3A concurrently, the rail connection interface 114 may be machine bored until a predetermined diameter is reached (Step 305). The machining may include the creation of retaining features, such as, for example, under cuts, grooves, threads or fiction/bonding surfaces. The predetermined diameter may be the outer diameter (O.D._{Insert}) of the insert 214. If a determination is made that the diameter (D_{interface}) of the machined interface is approximately equal to the outer diameter (O.D._{Insert}) of the insert 214 (YES at Step 310), then the insert 214 may be installed in the inlet port 112 of the control valve body 110 (Step 315), otherwise the insert 114 may be further machined (NO at Step 310, then Step 305).

After the insert 214 is installed in the control valve body 110, a determination may be made whether the inner diameter (I.D._{Insert}) of the insert 214 is approximately equal to a predetermined diameter (D_{Fluid Inlet Port}) of the fluid inlet port 112 (Step 320), such as, for example, an OEM specified diameter (D_{Fluid Inlet Port}). If it is determined that the inner diameter (I.D._{Insert}) of the insert 214 is not approximately equal to the predetermined diameter (D_{Fluid Inlet Port}) of the fluid inlet port 112 (NO at Step 320), then the inner walls of the insert 214 may be machined (Step 325) until the inner diameter (I.D._{Insert}) of the insert 214 is approximately equal to the predetermined diameter (D_{Fluid Inlet Port}) of the fluid inlet port 112 (YES at Step 320), otherwise the process ends (YES at Step 320).

FIG. 3B shows another example of a restoring process 300B that may be performed to restore the rail connection interface 114 to, for example, OEM specifications. Referring to FIGS. 2 and 3B concurrently, the rail connection interface 114 may be prepared for the deposition of a layer of a deposition material (Step 330). The deposition material is sufficiently hard and durable, at least as hard and durable as the original material of the control valve body 110. The preparation (Step 330) may include, for example, cleaning the interface 114. The preparation (Step 330) may also include, for example, depositing a bonding substrate, such as, for example, Nickel, Chromium, or the like, on the interface 114. After preparation of the interface 114 (Step 330), a material may be deposited onto the interface 114 (Step 335). The specific material and method of deposition may vary, as will be appreciated by those having ordinary skill in the relevant art, without departing from the scope or spirit of the disclosure, so long as the deposited material is at least as hard as the original material of the control valve body 110.

A determination may be made as to whether the deposited layer of material is of a sufficient thickness to provide the predetermined diameter (D_{Fluid Inlet Port}) of the fluid inlet port 112 (Step 340). If a determination is made that the inner diameter (I.D._{Interface}) of the interface 114 is not equal to the predetermined diameter (D_{Fluid Inlet Port}) of the fluid inlet port (NO at Step 340), then additional material may be deposited onto the surface of the interface 114 (Step 335), otherwise the process 300B ends (YES at Step 340). It is noted that the material may be deposited onto the interface 114 substantially uniformly.

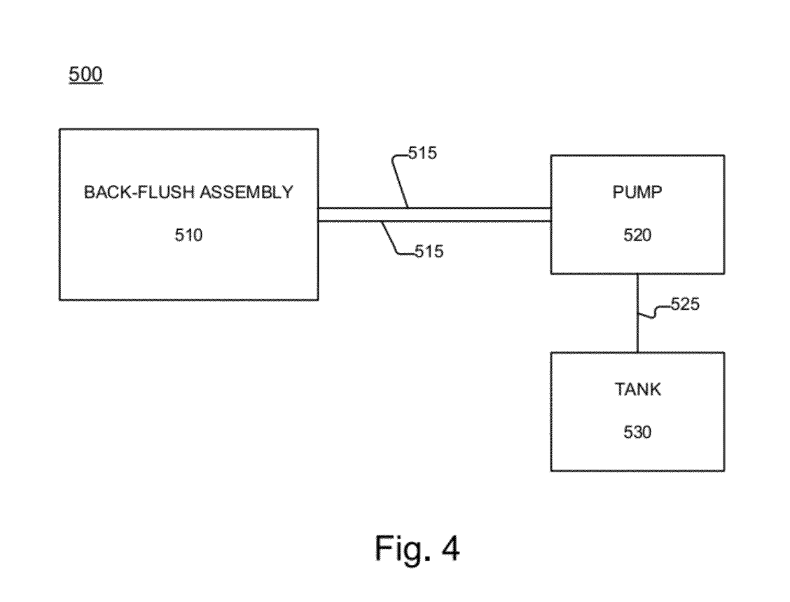

FIG. 4 shows an example of a cleaning system 500 that is constructed according to the principles of the disclosure. The cleaning system 500 includes a back-flush assembly 510, a pump 520 and a tank (or reservoir) 530. The cleaning system 500 may combine pressure and vibration to clean fuel injectors, such as, for example the fuel injector 100 shown in FIG. 1. The cleaning system 500 may further include a computer (not shown) for controlling operation of the back-flush assembly 510 and the pump 520.

The back-flush assembly 510 is configured to receive one or more fuel injectors, such as, for example, the fuel injector 100 shown in FIG. 1. The back-flush assembly 510 may include one or more flush lines (not shown) that may be connected to at least one of, for example, the nozzle 131 (shown in FIG. 1) and a fuel inlet hole or port of, for example, the cone nut of the fuel injector 100. The flush lines may carry pressurized cleaning solution to (or from) the nozzle 131 and/or the fuel inlet hole in the cone nut of the fuel injector 100.

The back-flush assembly 510 is in fluid communication with the pump 520 via supply/return lines 515. The back-flush assembly 510 is configured to receive a pressurized cleaning solution from the pump 520 via the supply/return lines 515 and to introduce the cleaning solution into, for example, the nozzle 131 of the fuel injector 100. The back-flush assembly 510 may be further configured to collect the cleaning solution from, for example, the fuel inlet holes of the cone nut, after the cleaning solution has travelled through the fuel lines of the fuel injector 100. The used cleaning solution may be returned to the pump 520 via the supply/return lines 515, or the used cleaning solution may be supplied to a waste tank (not shown) through a waste line (not shown), so that the used cleaning solution may be disposed of properly.

The back-flush assembly 510 is further configured to reverse flow direction and supply the pressurized cleaning solution via the one or more flush lines (not shown) to the fuel inlet holes of, for example, the cone nut. In this regard, the back-flush assembly 510 may collect the cleaning solution at the nozzle 131, after the cleaning solution has traveled through the fuel lines of the fuel injector 100.

The pump 520, which may include one or more pumps, may be coupled to the tank 530 via a supply line 525. The tank 530 holds the cleaning solution, which is capable of removing combustion byproducts. The cleaning solution may include any one or more of the cleaning solutions known at the time that this description was written, including cleaning solutions that were known by those having ordinary skill in the art to be capable of removing combustion byproducts, such as, for example, coking byproducts. The cleaning solution may include chemical and/or biological reagents, as is known in the relevant art.

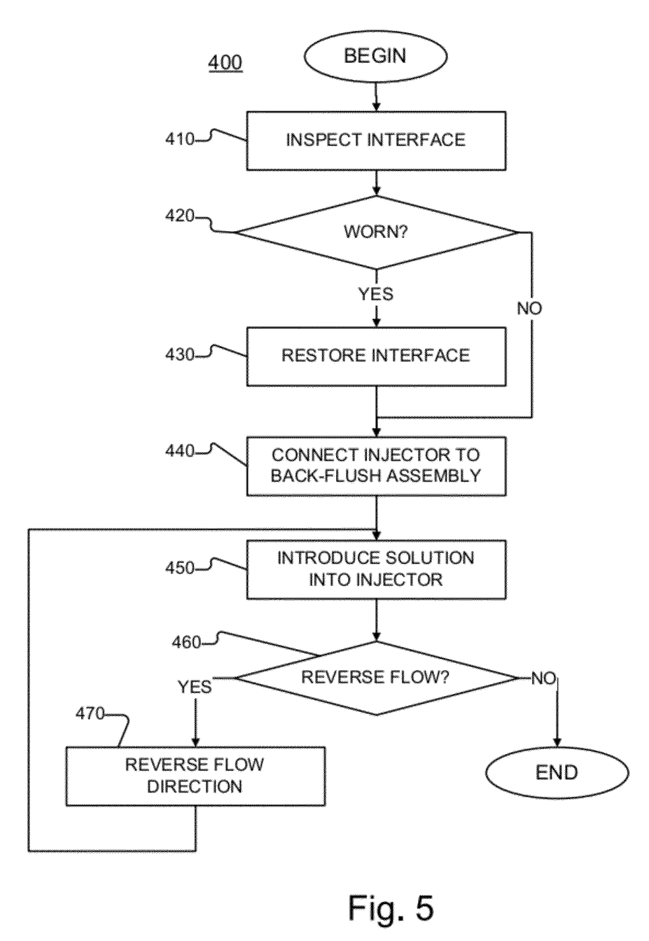

FIG. 5 shows an example of a cleaning process 400, according to the principles of the disclosure. Referring to FIGS. 1, 2, 4 and 5 concurrently, a fuel injector 100 (shown in FIG. 1) may be received for cleaning. The rail connection interface 114 (shown in FIG. 2) of the fuel injector 100 may be inspected for wear or damage (Step 410). Should a determination be made that the interface 114 is sufficiently worn to require restoration (YES at Step 420), then the interface 114 of the control valve body 110 may be restored using either (or both) of the processes 300A, 300B (shown in FIGS. 3A, 3B) (Step 430), otherwise the fuel injector 100 may be placed in and/or connected to the back-flush assembly 510 (shown in FIG. 4) for cleaning (NO at Step 420, then Step 440). It is noted that the Steps 410 to 430 may be optional. A cleaning solution may be received from the tank 530 and pressurized by the pump 520, and supplied to the back-flush assembly 510, which introduces the pressurized cleaning solution into the nozzle 131 (or fuel inlet hole of the cone nut) of the fuel injector 100 (shown in FIG. 1) (Step 450). The used cleaning solution may be collected at the inlet holes of the cone nut (or the nozzle 131).

A determination may be made whether to reverse flow direction of the cleaning solution (Step 460). If a determination is made to reverse flow direction (YES at Step 460), then the flow direction may be reversed (Step 470) and the pressurized cleaning solution may be introduced into the fuel inlet holes of the cone nut (Step 460), otherwise the process may end. The used cleaning solution may be collected from the nozzle 131.

According to an aspect of the disclosure, the processes 300A, 300B, and 500 may be automated and carried out under the control of a computer (not shown). In this regard, a computer readable medium may be provided that includes a computer program tangibly embodied therein. The computer program may include a section (or segment) of code that, when executed on the computer, may cause some or all of the Steps 310 to 340 of FIGS. 3A, 3B, and Steps 410 to 470 of FIG. 5 to be carried out.

While the disclosure has been described in terms of exemplary embodiments, those skilled in the art will recognize that the disclosure can be practiced with modifications in the spirit and scope of the appended claims. These examples given above are merely illustrative and are not meant to be an exhaustive list of all possible designs, embodiments, applications or modifications of the disclosure.

What is claimed is:

1. A method for restoring a rail connection interface of a fuel injector and cleaning the fuel injector, the method comprising:
inspecting a rail connection interface of the fuel injector;
restoring the rail connection interface;
connecting a flush line to at least one of a nozzle or a fuel inlet hole of a cone nut of the fuel injector;
pressurizing a cleaning solution; and
supplying the pressurized cleaning solution to the flush line.

2. The method according to claim 1, further comprising:
vibrating the pressurized cleaning solution.

3. The method according to claim 1, wherein the cleaning solution comprises:
a chemical agent; or
a biological agent.

4. The method according to claim 1, wherein the restoring the rail connection interface comprises:
machining the rail connection interface; and
installing an insert in the machined connection interface.

5. The method according to claim 1, wherein the restoring the rail connection interface comprises:
preparing the rail connection interface; and
depositing a material on the prepared rail connection interface.

6. The method according to claim 5, wherein the preparing the rail connection interface comprises:
cleaning the rail connection interface.

7. The method according to claim 5, wherein the preparing the rail connection interface comprises:
depositing a bonding substrate to the rail connection interface.

8. The method according to claim 1, wherein the supplying the pressurized cleaning solution to the flush line comprises:
introducing the pressurized cleaning solution into the nozzle of the fuel injector.

9. The method according to claim 1, wherein the supplying the pressurized cleaning solution to the flush line comprises:
introducing the pressurized cleaning solution into the fuel inlet hole of the cone nut of the fuel injector.

10. A method for cleaning a fuel injector, the method comprising:
connecting a flush line to at least one of a nozzle or a fuel inlet hole of a cone nut of the fuel injector;
pressurizing a cleaning solution; and
supplying the pressurized cleaning solution to the flush line.

11. The method according to claim 10, further comprising:
vibrating the pressurized cleaning solution.

12. The method according to claim 10, wherein the cleaning solution comprises:
a chemical agent; or
a biological agent.

13. The method according to claim 10, wherein the supplying the pressurized cleaning solution to the flush line comprises:
introducing the pressurized cleaning solution into the nozzle of the fuel injector.

14. The method according to claim 10, wherein the supplying the pressurized cleaning solution to the flush line comprises:
introducing the pressurized cleaning solution into the fuel inlet hole of the cone nut of the fuel injector.

15. A method for restoring a rail connection interface of a fuel injector, the method comprising:
inspecting a rail connection interface of the fuel injector; and
restoring the rail connection interface.

16. The method according to claim 15, wherein the restoring the rail connection interface comprises:
machining the rail connection interface; and
installing an insert in the machined connection interface.

17. The method according to claim 15, wherein the restoring the rail connection interface comprises:
preparing the rail connection interface; and
depositing a material on the prepared rail connection interface.

18. The method according to claim 17, wherein the preparing the rail connection interface comprises:
cleaning the rail connection interface.

19. The method according to claim 17, wherein the preparing the rail connection interface comprises:
depositing a bonding substrate to the rail connection interface.
